(19) United States
(12) Patent Application Publication
(10) Pub. No.: US 2024/0239220 A1
(43) Pub. Date: Jul. 18, 2024

(54) ELECTRIC VEHICLE

(71) Applicant: POLITECNICO DI TORINO, Torino (IT)

(72) Inventors: Paolo PESCETTO, Torino (IT); Gianmario PELLEGRINO, Torino (IT)

(73) Assignee: POLITECNICO DI TORINO, Torino (IT)

(21) Appl. No.: 18/557,984

(22) PCT Filed: Apr. 29, 2022
(86) PCT No.: PCT/IB2022/053982

§ 371 Date: Oct. 30, 2023

(30) Foreign Application Priority Data
Apr. 30, 2021 (IT) 102021000011036

(51) Int. Cl. B60L 53/24; B60L 53/14

(52) U.S. Cl. CPC B60L 53/24; B60L 53/14; B60L 2210/30; B60L 2210/42; B60L 2240/527

(57) ABSTRACT

Electric vehicle comprising at least one recharging apparatus of at least one battery, in which said apparatus comprises a power supply station configured to be electrically connected to a source of electric power supply, a conversion station, electrically connected to said feeding station and configured to convert said electric feeding power into an electric charging power able to charge said battery, said conversion station of said recharging apparatus comprises at least one galvanic separation device electrically interposed between said power supply station and said battery and configured to electrically separate said battery from said source of electric power supply, in which said galvanic separation device comprises a double-winding electric motor, in which a first winding is electrically connected with said power supply station and in which a second winding is electrically connected with said battery.

### CROSS REFERENCE TO THE RELATED APPLICATIONS

This application is the national phase entry of International Application No. PCT/IB2022/053982, filed on Apr. 29, 2022, which is based upon and claims priority to Italian Patent Application No. 102021000011036, filed on Apr. 30, 2021, the entire contents of which are incorporated herein by reference.

### TECHNICAL FIELD

The present invention relates to an electric vehicle, and in particular an electric vehicle for the transport of at least one passenger.

### BACKGROUND

The vehicle in question could advantageously be an electric vehicle of the land type, or intended to advance on the ground, or otherwise it could be a naval vehicle or even an air vehicle.

In this situation, the electric vehicle object of the present invention finds advantageous use in the technical sector of the production and marketing of electric vehicles for the transport of at least one passenger or in the technical sector of the production and marketing of devices intended to be installed in vehicles, such as in particular equipment for recharging batteries mounted on board the aforementioned vehicles.

In the technical sector of electric vehicles, electric vehicles equipped with electric traction motors, i.e., suitable for moving the vehicle forward, powered by a rechargeable battery by means of an external electric power, have been known for some time.

In particular, electric vehicles known in jargon with the term “plug-in” are known in the technical sector, i.e., vehicles configured to be electrically connected to an external charging station, to electrically charge the aforementioned battery which powers the electric motor.

Normally, in the case of land electric vehicles, such as electric cars, the recharging takes place by means of the electrical connection of a power source, for example comprising a turret for the distribution of recharging electric energy, with a recharging apparatus installed on board the vehicle. In particular, recharging takes place by inserting an electrical connector of the turret itself into a special housing provided on the vehicle, placed in electrical connection with the charging device and therefore with the battery to be recharged.

Normally, the charging towers are configured to deliver alternating electrical power, in particular the electrical power of the distribution network.

It has long been known in the technical sector of reference to use, within the recharging apparatus, rectifying devices, designed to convert the alternating voltage of the power supply network into a direct voltage suitable for charging an electric battery.

Such apparatuses comprise, in a manner well known to those skilled in the art, a plurality of electrical components, electrically connected to each other, such as in particular capacitors and inductors, as described in more detail below.

In particular, among the components necessary for the correct functioning of the recharging apparatuses, the inductors are very bulky and heavy as well as being very expensive.

In this situation, electric vehicles equipped with recharging apparatuses of the known type have proved to be not free from drawbacks in practice.

The main drawback lies in the fact that the devices are extremely bulky inside the vehicle, reducing the space available for all the other devices needed in the vehicle itself.

A further drawback lies in the fact that the recharging apparatuses of known types of vehicles are extremely heavy, increasing the overall weight of the vehicle and therefore reducing the performance of the vehicle itself during its movement, increasing consumption.

A further drawback lies in the fact that recharging apparatuses of the known type are very expensive and complex to produce, considerably increasing the cost of the electric vehicle.

In order to at least partially obviate the drawbacks of the aforementioned prior art, it is known to produce electric vehicles equipped with recharging equipment in which at least a part of the inductors of the apparatus itself is replaced by the windings of at least one electric traction motor of the vehicle itself.

In this way, the apparatus thus created obviates the need to provide many dedicated inductors.

An example of such known electric vehicles, equipped with recharging apparatuses that exploit the windings of the traction motor is described in US 2012/0286740.

A circuit diagram of the recharging apparatus described in this prior art document is illustrated in the attached FIG. 1.

With particular reference to this annexed FIG. 1, the vehicle apparatus of the known type comprises, from left to right, a connection A to an external power source, such as in particular the electrical network, a first conversion device B, a second conversion device C, which is electrically connected to a battery D of the electric vehicle to recharge it.

More in detail, the first conversion device B comprises a rectifier E, electrically connected to connection A to the external electrical source, in particular made by means of a three-phase bridge with controllable switches and configured to convert a three-phase alternating supply voltage into a direct voltage.

The first device B further comprises a DC/DC converter, in particular a voltage converter adapted to lower the value of the direct voltage converted by the rectifier E.

This device B is electrically connected to the battery D to charge it with the direct voltage output from the converter.

The apparatus described therein also comprises an electric motor M and a corresponding inverter C electrically interposed between the device B and the battery D.

The motor M is electrically connected in series to the rectifier E and acts as an inductance inside the voltage reducer F. In fact, as is known, the reducing buck circuit requires an inductance in parallel with a recirculating diode. The prior art vehicle described therein therefore provides for the replacement of a dedicated inductance with the inductance of the traction motor on board the vehicle.

While charging battery D, the inverter C of the motor M is used as a simple closed circuit to allow the continuous voltage (and current) to charge the battery D itself.

More in detail, during recharging, a first series G of controllable switches of the inverter C are closed while a second series H of controllable switches of the inverter C are open, thus allowing a unitary path to the direct current converted by the rectifier E. direct current flowing through the closed switches G of the converter C supplies the battery D to recharge it.

However, even the electric vehicle equipped with the charging device briefly described up to now has proved to be not free from drawbacks in practice.

The main drawback lies in the fact that the vehicle's recharging apparatus of a known type is devoid of electrical safety systems, i.e., does not provide in any way to galvanically separate the battery from the power supply in the event of faults.

A further drawback lies in the fact that, in the event of malfunctions of the electronic components of the recharging apparatus, the vehicle of the known type is subject to damage to the battery, for example due to overvoltages and/or overcurrents.

In this situation, the direct electrical connection between the power supply source and the battery carries the inherent risk of damaging the battery, which, as is known, is a very expensive and delicate component of any electric vehicle.

From document EP3006257A1 an apparatus for controlling the recharging of a battery in an electric vehicle is known in which an electric traction motor is used as a transforming device for recharging an internal vehicle battery. However, while ensuring the galvanic isolation of the battery during the charging phase, this apparatus envisages the use of electronic devices for the conversion of controlled type power both upstream and downstream of the controlled type electric motor.

In particular, the apparatus described therein comprises a controlled rectifier and a filter, electrically connected to the power supply. These devices must necessarily be controlled and controlled in an active way, as it is necessary to transform voltage and current by limiting the harmonics of current as much as possible to prevent unwanted electromagnetic inductions.

Obviously, these controlled type electronic devices are very complex and expensive, increasing the overall cost of the device.

A further drawback lies in the fact that the known type control apparatus provides for the provision of an electronic rectifier device between the electric motor and the battery. This rectifier device is of the active type, i.e., controlled by an electronic control unit and is complex and expensive to install.

### SUMMARY

Therefore, the object of the present invention is to propose an electric vehicle which allows to overcome, at least partially, the drawbacks of the aforementioned known art.

A further object of the present invention is to provide an electric vehicle which allows the battery to be recharged in total safety.

A further object of the present invention is to provide an electric vehicle that allows the battery to be recharged, obviating the risk of electrically charging the body and/or bodywork of the vehicle, in particular obviating the risk of the formation of unwanted common mode currents.

A further object of the present invention is to provide an electric vehicle which can safeguard the battery even in the event of malfunctions.

A further object of the present invention is to provide an electric vehicle which allows to reduce the production costs of its recharging apparatus.

A further object of the present invention is to provide an electric vehicle which is equipped with a recharging apparatus of reduced bulk.

A further object of the present invention is to provide an electric vehicle which is equipped with a low-weight recharging apparatus.

Another purpose of the invention is to provide an electric vehicle that is constructively completely reliable.

Another purpose of the invention is to propose an electric vehicle that has an alternative characterization, both in constructive and functional terms, with respect to traditional ones.

Another purpose of the invention is to propose an electric vehicle that can be obtained simply, quickly and with low costs.

Another purpose of the invention is to propose an electric vehicle that can be mass-produced and quickly and efficiently.

These objects, both individually and in any combination thereof, as well as others that will emerge from the following description, are achieved, according to the invention, with an electric vehicle with the characteristics indicated in claim 1.

In particular, the aforementioned purposes are at least partially achieved by an electric vehicle comprising at least one recharging apparatus 100 for at least one battery 2, in which said apparatus comprises a power supply station 3 configured to be electrically connected to a source 4 of electrical power of power supply, a conversion station 5, electrically connected to said power supply station 3 and configured to convert said electric power supply into an electric recharging power suitable for charging said battery 2. Said conversion station 5 of said recharging apparatus 100 comprises at least one galvanic separation device 6 electrically interposed between said power supply station 3 and said battery 2 and configured to electrically separate said battery 2 from said source 4 of electric power supply, in which said galvanic separation device 6 comprises a double-winding electric motor 10 adapted to allow the movement of said vehicle 1, in which a first winding 11 is electrically connected with said power supply station 3 and in which a second winding 12 is electrically connected with said battery 2 and magnetically coupled and electrically separated with respect to said first winding 11.

### BRIEF DESCRIPTION OF THE DRAWINGS

The present invention is further clarified hereinafter in a preferred embodiment thereof reported for purely illustrative and non-limiting purposes with reference to the attached drawing tables, in which:

FIG. 1 shows a schematic circuit view of a recharging apparatus of an electric vehicle of the prior art,

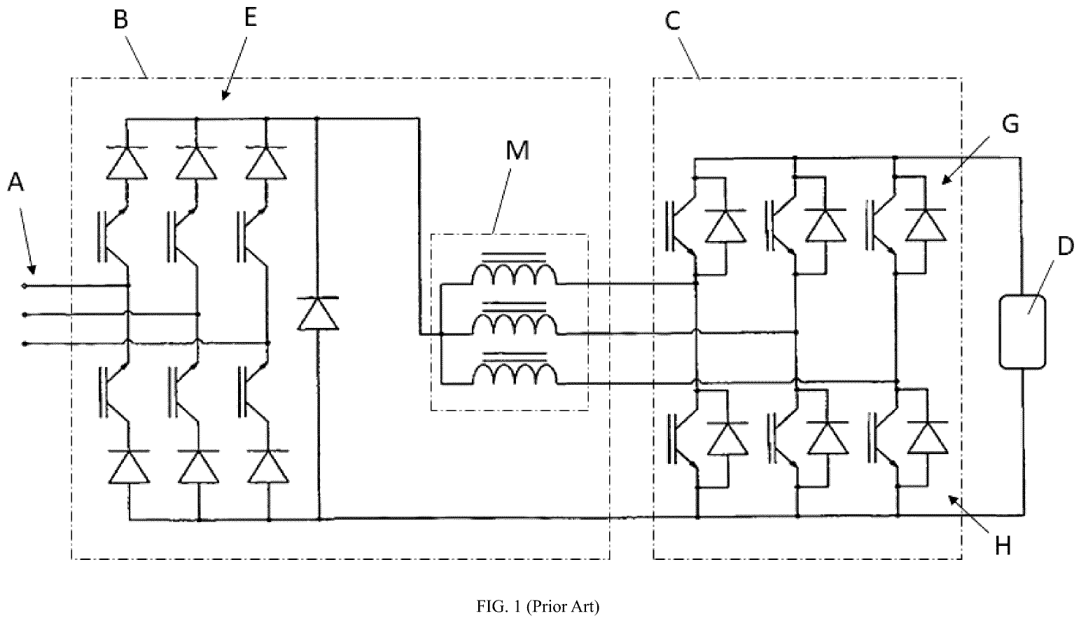

FIG. 2 shows a schematic side view of an electric vehicle object of the present invention;

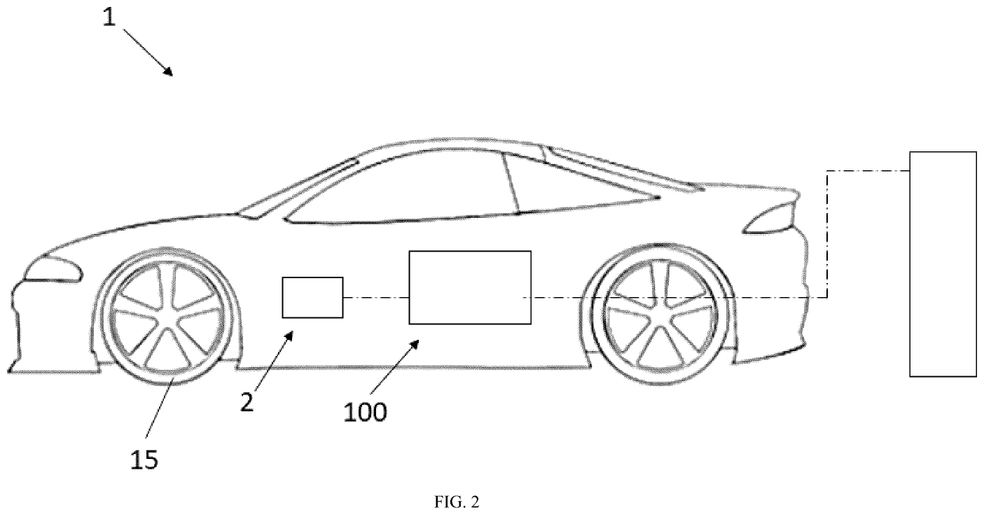

FIG. 3 shows a schematic circuit view of a recharging apparatus for a battery of the electric vehicle of FIG. 2 object of the present invention, variable in a traction configuration and in a recharging configuration;

FIG. 4 shows a schematic circuit view of a recharging apparatus for a battery of the electric vehicle of FIG. 2 object of the present invention, in the recharging configuration;

FIG. 5 shows a schematic circuit view of a battery recharging apparatus of the electric vehicle of FIG. 2 object of the present invention, in the traction configuration;

FIG. 6 shows a block diagram of a detail of the recharging apparatus of a battery of the electric vehicle of FIG. 2 object of the present invention, concerning control and command means of an inverter device in a first embodiment thereof;

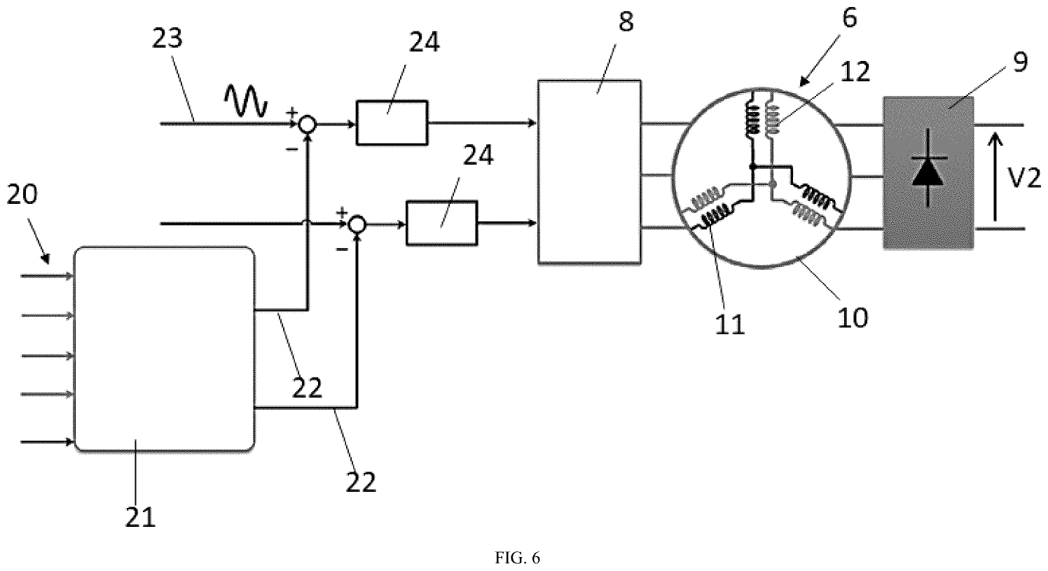

FIG. 7 shows a block diagram of a detail of the recharging apparatus of a battery of the electric vehicle of FIG. 2 object of the present invention, concerning control and command means of an inverter device in a second embodiment thereof.

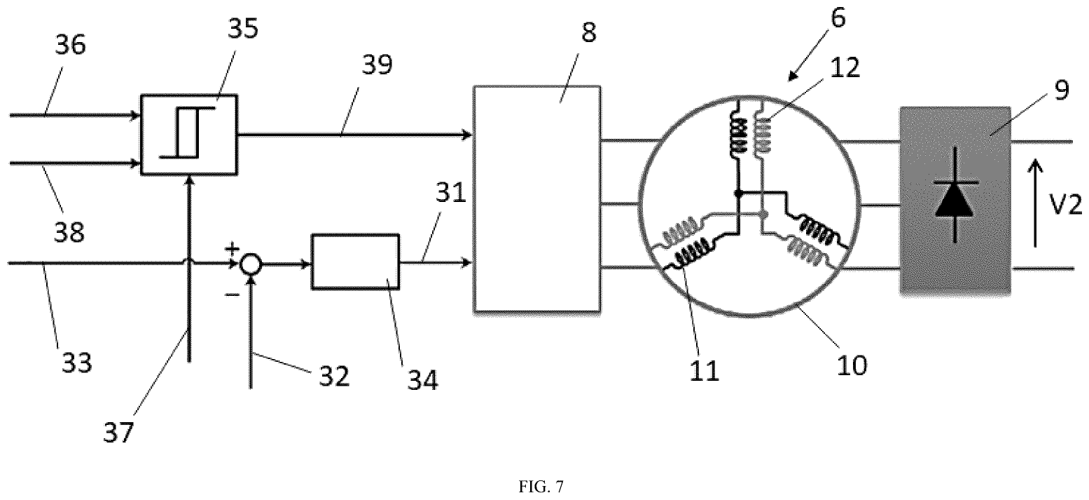

### DETAILED DESCRIPTION OF THE EMBODIMENTS

As is evident from the attached figures, the electric vehicle according to the present invention has been indicated as a whole with the numerical reference 1.

The vehicle in question is advantageously used in the production and marketing of electric vehicles and, more particularly, in the production and marketing of electrically powered vehicles for the transport of at least one passenger.

Pursuant to this description, the term “vehicle” shall hereinafter be understood as any type of device suitable for the transport of people and/or objects, such as for example electric bikes, electric scooters, mopeds, cars, airplanes, ships, and similar.

The electric vehicle 1 object of the present invention comprises at least one recharging apparatus 100 for at least one battery 2.

The term “recharging device” shall mean in the following, and according to the definition of the scope of protection of this patent, any substantially electrical system capable of allowing the recharging of a battery 2 advantageously provided on board the electric vehicle 1 or a pack of batteries 2, provided on board the vehicle 1 itself.

Conveniently, the apparatus 100 comprises a power supply station 3 configured to be electrically connected to a source 4 of electric power supply.

Advantageously, the power supply station 3 of the apparatus 100 provides a connection section 13 configured to be electrically connected to the aforementioned source 4, which normally comprises a terminal 14 of a power supply network.

The terminal 14 can be made in particular by means of at least one connector (not illustrated in the attached figures and per se well known to those skilled in the art) and can provide a single-phase or three-phase connection, without thereby departing from the scope of protection of this patent.

The connection section 13 conveniently provides at least one housing (not shown) for the aforementioned connector, advantageously provided for connection between the inside of the vehicle and the outside, in particular to electrically connect the circuits provided inside the vehicle 1 with the source 4.

Conveniently, the apparatus according to the invention provides that the source 4 is suitable for delivering an electric current of the sinusoidal type, advantageously in phase with the supply voltage, such as for example the electric power supplied by the electric power distribution network. Obviously, the vehicle apparatus according to the invention can be connected to a direct current electrical power source without thereby departing from the scope of protection of this patent.

The apparatus 100 of the vehicle 1 object of the present invention advantageously comprises a conversion station 5, electrically connected to the power supply station 3 and configured to convert the electric power supply into an electric recharging power suitable for charging the battery 2.

Advantageously, the power supply station 3 is mounted on board the vehicle and comprises at least one inductor configured to be electrically connected in series with the power supply network. Conveniently, in the event that the power supply is three-phase, the power supply station 3 includes three inductors each configured to be connected in series with a corresponding phase of the three-phase power supply network.

More in detail, the conversion station is configured to convert, by means of one or more devices described in detail below, the electric power supply (usually alternating power) into recharging power, in particular to direct voltage and current.

Conveniently, the conversion station 5 of the recharging apparatus 100 comprises at least a galvanic separation device 6 electrically interposed between the power supply station 3 and the battery 2 and configured to electrically separate the battery 2 from the source 4 of electric power supply.

Advantageously, the galvanic separation device 6 comprises a double-winding electric motor 10 suitable for allowing the movement of the vehicle 1 itself, in which a first winding 11 is electrically connected to the power supply station 3 and in which a second winding 12 is electrically connected to the battery 2 and magnetically coupled and electrically separated with respect to the first winding 11.

In this way, the electric vehicle 1 object of the present invention allows to obtain a safe and reliable recharging of the battery 2.

In particular, the vehicle 1 object of the invention allows the battery 2 to be recharged by keeping it galvanically separated from the power source 4, obviating the risk of damaging the battery 2 itself due to overvoltages and/or overcurrents.

In addition, the galvanic separation guaranteed by the galvanic separation device 6 allows to obtain protection for the user who recharges the vehicle. In fact, the galvanic separation device 6 allows to obviate the formation of currents, in particular common mode currents, which could electrically charge the body of the electric vehicle 1, becoming dangerous for the user himself.

In this way, the vehicle 1 according to the invention overcomes the drawbacks of the known art, allowing to obtain a safe connection of the battery to the source and, at the same time, to reduce the weight and cost of the known type of recharging equipment.

Conveniently, the electric motor 10 of the electric vehicle 1 according to the invention is an electric traction motor, that is, it is an electric motor used for the actuation of means for moving the vehicle 1 itself.

For example, if the vehicle 1 is of the land type, the electric motor 1 is configured to rotate wheels 15 to make the vehicle 1 move on the ground.

On the other hand, in the case in which the vehicle 1 is of the naval type, the electric motor 10 is configured to rotately activate propellers intended to be immersed in water for the movement of the naval vehicle.

Differently again, in the case in which the vehicle 1 is of the aerial type, the electric motor 10 is configured to activate the propellers of jet engines or the like.

Obviously, the electric motor 10 can be used for the movement of any type of vehicle and can be provided alone or coupled with one or more further electric motors, both of the same type and of different types, without thereby abandoning the scope of protection. of this patent.

Conveniently, the conversion station 5 comprises at least a first rectifier device 7, electrically connected to the power supply station 3 and configured to convert an alternating electrical voltage of the electrical supply power into a first substantially continuous electrical voltage V1.

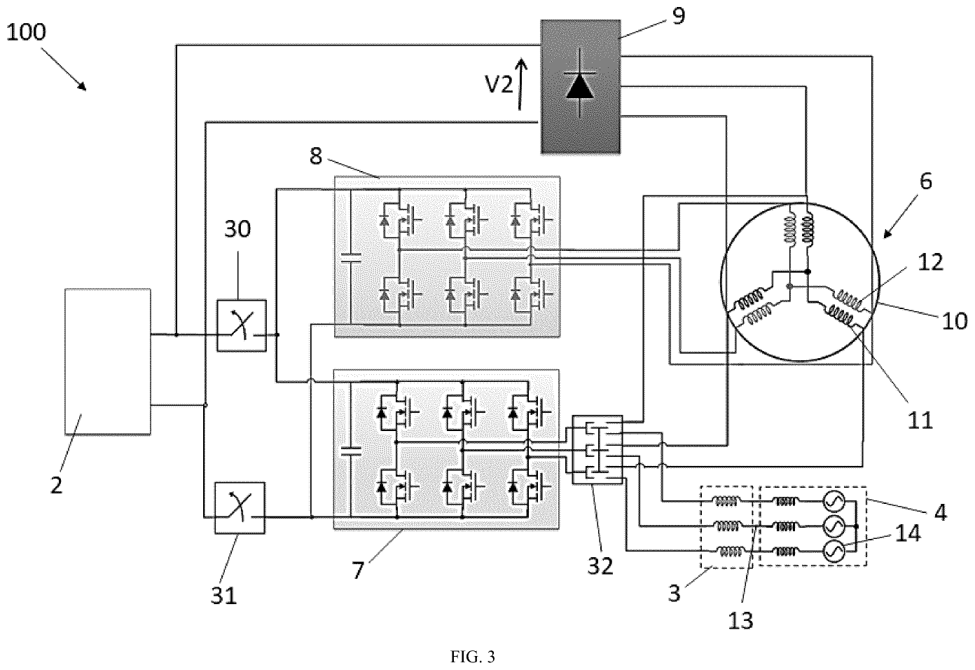

Advantageously, the first rectifier device 7 comprises at least one bridge of controllable switches, in accordance with the preferential embodiment illustrated in the attached FIG. 3, and preferably a three-phase bridge of controllable switches to allow also rectifying a three-phase supply voltage.

Conveniently, the first rectifier device 7 (and preferably also the inverter device 8) is a traction inverter, i.e., an inverter associated with the electric motor 10 to control its electrical power supply.

Conveniently, the conversion station 5 further comprises at least one inverter device 8 electrically interposed between said first rectifier device 7 and the galvanic separation device 6, configured to convert the first substantially continuous electrical voltage V1 into a first three-phase alternating electrical voltage.

Advantageously, the inverter device 8 comprises an inverter, preferably a three-phase inverter, modulated by an electronic control unit. Advantageously, the inverter device 8 is modulated in pulse width (PWM).

Advantageously, the switching frequency of the pulse width switching of the inverter device 8 is greater than 1 kHz and preferably greater than 10 kHz.

Conveniently, the inverter device 8 is configured to generate the first three-phase alternating electrical voltage with a frequency between 500 Hz and 5 kHz.

Preferably, the inverter device 8 is configured to generate the first three-phase alternating electrical voltage with a frequency comprised between 500 Hz and 1 kHz and more preferably comprised between 500 Hz and 800 Hz.

In this way, the first three-phase alternating electrical voltage flowing in the first winding 11 of the electric motor 10 of the galvanic separation device is a high-frequency voltage that generates a corresponding high-frequency alternating magnetic field that chains the second winding 12 of the electric motor 10 same.

In accordance with the preferential embodiment illustrated in the attached figures, the electric motor 10 is a motor comprising a stator equipped with a first three-phase winding 11 electrically connected to the inverter device 8 of the conversion station 5 and a second three-phase winding 12 electrically connected to the battery 2, magnetically coupled to the first three-phase winding 11 and able to be crossed by a second three-phase alternating voltage induced by said first three-phase alternating electrical voltage.

In this way, the first three-phase alternating electrical voltage of the first winding 11 generates the aforementioned three-phase magnetic field which links the second three-phase winding, inducing in the latter a corresponding three-phase voltage.

Conveniently, the first three-phase winding 11 and the second three-phase winding 12 magnetically coupled are configured to act as a three-phase transformer thus defining the aforementioned galvanic separation.

In fact, the first and second windings 11, 12 of the electric motor 10 are advantageously provided with respective electrically separated star centers, in order to avoid direct electrical connections, acting as a three-phase transformer, with the rotor of the motor without driving torque.

More in detail, the inverter device 8 is configured to generate the aforementioned first three-phase alternating electrical voltage in such a way that the drive torque is zero at the rotor of the electric motor 10.

Advantageously, the conversion station 5 comprises a second rectifier device 9 electrically interposed between the galvanic separation device 6 and the battery 2 and configured to convert the second three-phase alternating voltage into a second substantially continuous voltage V2 to charge the battery 2.

Advantageously, second rectifier device 9 is of the passive type. More in detail, said second rectifier device 9 is not controlled from the outside, in particular it is not electronically controlled during its operation.

For example, second rectifier device 9 is made by means of a three-phase semiconductor bridge, for example a three-phase bridge of diodes or the like.

Conveniently, said power supply station 3 is directly connected to said conversion station 5. Conveniently, in accordance with the preferred embodiment illustrated in the attached figures, the vehicle 1 does not provide filters interposed between the power supply station 3 and the conversion station 5.

Advantageously, the electric vehicle 1 according to the invention comprises at least one electronic control unit electronically connected with said inverter device 8 and with said first rectifier device 7, and configured to control said first substantially continuous electrical voltage V1 and said first three-phase alternating electrical voltage.

Preferably, the first substantially continuous voltage V1 delivered by the first rectifier device 7 is always greater than the second substantially continuous voltage V2 delivered by the second rectifier device 9.

Conveniently, the first continuous voltage V1 is greater than or equal to 310V if the source 4 of electric power supply is single-phase and, conveniently, the first voltage V1 is greater than or equal to 560V if the source 4 is three-phase.

Advantageously, the first rectifier device 7 and the inverting device 8 are constructively identical, i.e., equipped with the same bridge with controllable switches, preferably a three-phase bridge of controllable switches.

Advantageously, the electric motor 10 is a permanent magnet synchronous motor and preferably a synchronous motor of the BPMSM type.

Conveniently, the electric vehicle 1 object of the present invention comprises at least one electronic control unit operatively associated with the power supply station 3 and the conversion station 5 and configured to detect electrical control quantities 20, comprising an electrical supply voltage and/or an electric current for supplying said electric power supply and/or an electric recharging voltage and/or an electric current for recharging said electric recharging power and for controlling said inverter device 8 to supply said first three-phase alternating electrical voltage controlled on the base of said electrical control quantities.

Advantageously, the electronic control unit comprises at least one microcontroller, for example a PLC and is operationally connected at least to the power supply station 3 and to the conversion station 5.

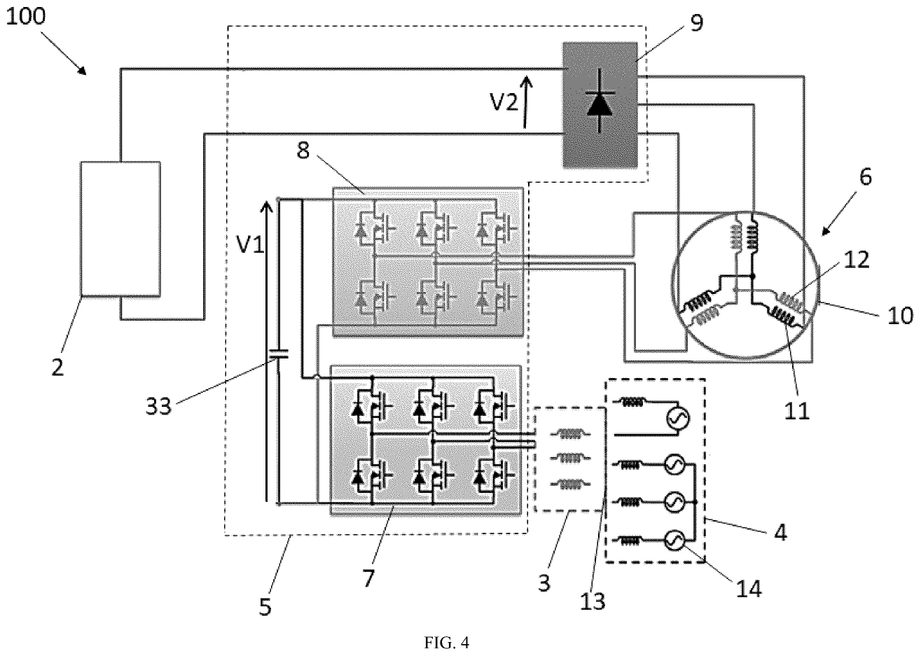

In accordance with the first embodiment of the present invention illustrated in the attached FIG. 4, the electronic control unit, and in particular its microcontroller, comprises at least one processing module configured to process said electrical control quantities and calculate at least one value of magnetic flux of the electric motor 10.

Advantageously, the vehicle according to the invention comprises first and second diverter means 30 and 31 electrically interposed between said first rectifier device 7, said inverter device 8 and said battery 2.

Preferably, the first and second diverter means 30, 31 are placed in electrical connection on the one hand with the first rectifier device 7 and the inverter device 8 and on the other with the battery 2. In particular, the first and second means diverters 30, 31 are placed to intercept a DC BUS common to the first rectifier device 7 and to the inverter device 8.

The term diverter means hereinafter means placed to intercept at least one electric cable configured to be able to interrupt the electrical connection between a first and a second terminal, in which a first user is electrically powered, and to simultaneously put in communication the first terminal with a third electrical terminal to power a second different user, in a reversible way.

Advantageously, said first and second diverter means 30, 31 being configured to connect said first rectifier device 7 and said inverter device 8 to said battery 2 in a traction configuration, to allow said battery 2 to power said electric motor 10.

The term “traction configuration” will hereinafter be understood as an electrical configuration that allows the electric motor 10 to be powered by an electric power supplied by the battery 2 of the vehicle 1 to allow the vehicle 1 itself to transit autonomously.

Conveniently, in accordance with a preferred but non-limiting embodiment of the present invention, in said traction configuration, second rectifier device 9 remains electrically connected to said battery 2 and said electric motor 10.

Advantageously, second rectifier device 9, in the traction configuration, automatically becomes inactive since it is in parallel with the first rectifier device 7. In other words, the second rectifier device 9 does not participate in energy conversion as it is not traversed by current. Preferably, said first and second diverter means 30, 31 being configured to separate said first rectifier device 7 and said inverter device 8 from said battery 2 (as illustrated in the attached FIG. 4) in a recharging configuration, to allow said station to recharge power supply 3 to recharge said battery 2.

The term “recharging configuration” will hereinafter be understood as an electrical configuration that allows the electrical connection between an external electrical power source with respect to the vehicle 1 and the battery 2 inside the vehicle 1, to allow the recharging of the battery 2 itself.

Advantageously, the vehicle according to the invention comprises third diverter means 32 electrically interposed between said first rectifier device 7 and second winding 12 of said electric motor 10.

Advantageously, third diverter means 32 are configured to connect said power supply station 3 to said first rectifier device 7 in the recharging configuration and to connect said first rectifier device 7 to second winding 12 of said electric motor 10 in the traction configuration.

Advantageously, second rectifier device 9 is a passive device not controlled from the outside.

Preferably, between said first rectifier device 7 and said inverter device 8 there is electrically connected in parallel at least one capacitor device 33. More preferably, a single capacitor device 33 is electrically connected in parallel between said first rectifier device 7 and said inverter device 8. the term capacitor device 33 di should preferably mean in the following a bank of capacitors connected together in series and/or parallel.

Advantageously, the single capacitor device 33 remains electrically connected in parallel to said first rectifier device 7 and to said inverter device 8 during the transition of the deviating means 30, 31, 32 between the recharging configuration and the traction configuration and vice versa.

Advantageously, the first three-phase alternating electrical voltage is controlled on the basis of said magnetic flux value.

Preferably, the electronic control unit is configured to receive, process and divide the electrical control quantities 20 into two groups of electrical quantities in two-phase coordinates (known in the technical jargon of the sector with the term of coordinates d and q).

Conveniently, the electronic control unit is configured to control the operation of the inverter device 8 by means of a feedback control and preferably a double-loop feedback control, in which a first feedback loop is configured to manage a first two-phase coordinate. and a second feedback loop is configured to manage a second coordinate of the two-phase coordinates.

Advantageously, the electronic control unit comprises a flux calculator 21, configured to receive the electrical control quantities 20, process them and estimate a magnetic flux value of the electric motor 10, preferably taking into account the contributions of both the first winding 11 and the second winding 12, and send a corresponding electric feedback signal 22 containing the magnetic flux value of the electric motor 10.

Preferably, the flux calculator 21 is configured to send two electrical feedback signals 22, one for each of the two two-phase coordinates.

The electronic control unit also provides an input of a pulsed magnetic flux reference value 23, with which to compare the electrical feedback signal 22, in the first of the two two-phase coordinates, and thus calculate a flux error.

The flux value in the second two-phase coordinate is instead compared with a zero flux value and calculates a corresponding flux error with respect to this null value.

The flux error is then sent to two regulators 24, advantageously two regulators, in particular integrative proportional regulators (PI) or resonant regulators, which calculate the reference voltages for the inverter device 8.

In this way, by appropriately setting the amplitude and frequency of the pulsed magnetic flux 23 of reference, it is possible to adjust the voltage induced by the first winding 11 on the second winding 12 and consequently regulate the charging current, and at the same time avoid excessive saturation. magnetic motor 10.

Conveniently, the reference pulsating magnetic flux 23 will be pulsating in the direction of the magnets of the permanent magnet electric motor 10, in order to produce zero torque to the rotor.

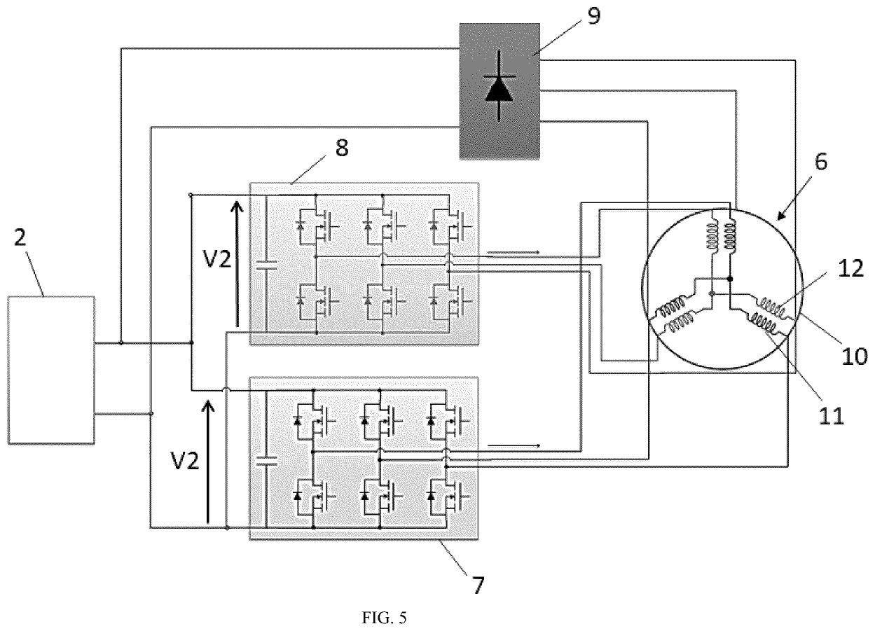

In accordance with a second embodiment of the present invention illustrated in the attached FIG. 5, the electronic control unit comprises at least one processing module configured to process electrical control quantities 20 and calculate at least one value of the sum of the electrical currents flowing in the first winding 11 and in the second winding 12 of said electric motor 10.

Advantageously, the first three-phase alternating electrical voltage is controlled on the basis of the value of the sum of the electric currents flowing in the first winding 11 and in the second winding 12 of the electric motor 10.

Advantageously, in accordance with this second embodiment, the inverting device 8 is controlled by means of a hysteresis control.

Conveniently, the electronic control unit is able to calculate the reference voltages for the inverter device 8 in two distinct two-phase coordinates.

The first reference voltage value 31 in the first two-phase coordinate is obtained by comparing the sum 32 of the currents flowing in the first and second windings 11, 12 of the electric motor 10 with a zero current value 33.

In other words, the electronic control unit comprises a controller 34, preferably of the proportional integrative type, configured to receive an electrical signal containing said zero current value 33 as a reference signal and an electrical signal containing said sum 32 of the flowing currents in the first and second winding 11, 12 of the electric motor 10 and correspondingly generate a reference voltage value in the first two-phase coordinate with which to control the inverter device 8.

Furthermore, the electronic control unit comprises a hysteresis controller 35 configured to receive an electrical voltage reference signal 36.

Advantageously, the hysteresis controller 35 is also configured to receive the value of the current 37 flowing in at least one winding 11, 12 of the electric motor 10 of the galvanic separation device 6.

Furthermore, advantageously, the hysteresis controller 35 is also configured to receive an electrical reference signal containing a threshold value 38 for the current of the windings 11, 12.

Conveniently, the polarity of the square wave 36 of the reference electrical signal of the hysteresis controller 35 is inverted whenever the current 37 exceeds the aforementioned predetermined threshold value 38.

Advantageously, the hysteresis controller 35 is configured to calculate, on the basis of the comparison between the reference electrical signal containing a voltage square wave 36 and the excess of the threshold value 38 by the current 37 of at least one of the windings 11 12, a second reference voltage value 39 in the second two-phase coordinate, in particular a voltage square wave, to drive the inverter device 8 together with the first reference voltage value 31 in the first two-phase coordinate.

In this way, the apparatus 100 of the vehicle 1 object of the present invention is controlled automatically, so that the first alternating voltage that runs through the first winding 11 induces on the second winding 12 a second alternating voltage to charge the battery 2.

The present invention also relates to a method for mounting an apparatus 100 for recharging at least one battery 2 in an electric vehicle 1.

The method according to the invention comprises at least one stage of preparation of the recharging apparatus 100 of at least one battery 2, which apparatus 100 comprises a power supply station 3 configured to be electrically connected to a source 4 of electric power supply.

Furthermore, the apparatus 100 comprises a conversion station 5, electrically connected to said power supply station 3 and configured to convert the electric power supply into an electric charging power suitable for charging said battery 2.

Advantageously, the conversion station 5 of the vehicle 1 and/or of the apparatus 100 is normally provided inside the vehicle 1 and in particular does not provide for any addition of further electrical and/or electronic components. This provision makes it possible to minimize production and engineering costs while allowing the battery 2 to be recharged in compliance with the regulations in force in the technical sector of reference.

Furthermore, the vehicle and/or the apparatus thus obtained only require the addition of passive elements (i.e., the second rectifier device 9).

Furthermore, the conversion station comprises at least one galvanic separation device 6 intended to be electrically interposed between said power supply station 3 and said battery 2 and configured to electrically separate the battery 2 from the source 4 of electric power supply, in which said device of galvanic separation (6) comprises a double-winding electric motor 10 adapted to allow the movement of said vehicle 1, in which a first winding 11 is electrically connected with said power supply station 3 and in which a second winding (12) is electrically connected with said battery 2 and magnetically coupled and electrically separated with respect to said first winding 11.

Conveniently, moreover, the method according to the invention provides at least one installation step of said recharging apparatus 100 inside said electric vehicle 1.

All the characteristics of the electric vehicle 1 and the recharging apparatus 100 described above are to be understood and disclosed as referring to the mounting method, which is also the subject of the present invention, without thereby departing from the scope of protection of this patent.

The invention thus conceived therefore achieves the intended purposes.

In particular, the electric vehicle 1 object of the present invention allows the battery 2 to be recharged in a safe and reliable manner.

Furthermore, the electric vehicle 1 allows the electrical power source 4 to be galvanically separated from the battery, obviating the risk of damaging the latter in the event of malfunctions.

In addition, the electric vehicle 1 and the apparatus 100 according to the invention exploit the conversion station 5 already normally provided and present on board the vehicle 1 providing only for the addition of a passive device, i.e., the addition of only the second rectifier device 9.

What is claimed is:

1. An electric vehicle comprising at least one recharging apparatus for at least one battery, wherein the recharging apparatus comprises:
a power supply station configured to be electrically connected to a source of electric power supply;
a conversion station, electrically connected to the power supply station and configured to convert an electric feeding power into an electric recharging power allowed to charge the battery;
wherein the conversion station of the recharging apparatus comprises at least one galvanic separation device electrically interposed between the power supply station and the battery and configured to electrically separate the battery from the source of electric power supply,
wherein the galvanic separation device comprises a double-winding electric motor adapted to allow a movement of the electric vehicle,
wherein a first winding is electrically connected with the power supply station and
wherein a second winding is electrically connected with the battery and magnetically coupled and electrically separated with respect to the first winding;
the conversion station comprises:
at least a first rectifier device, electrically connected to the power supply station and configured to convert an alternating electric voltage of the electric power supply into a first substantially continuous electrical voltage;
at least one inverter device electrically interposed between the said first rectifier device and the galvanic separation device, configured to convert the first substantially continuous electrical voltage into a first three-phase alternating electrical voltage;
a second rectifier device electrically interposed between the galvanic separation device and the battery and configured to convert a second three-phase alternating voltage into a second substantially continuous voltage to charge the battery;
wherein the second rectifier device is of passive type and the electric vehicle further comprises at least one electronic control unit electronically connected to the inverter device and to the first rectifier device, and configured to control the first substantially continuous electrical voltage and the first three-phase alternating electrical voltage.

2. The electric vehicle according to claim 1, wherein the power supply station is directly connected to the conversion station.

3. The electric vehicle according to claim 1, comprising first and second deviating means electrically interposed between the first rectifier device, the inverter device and the battery;
wherein the first and second deviating means are configured to connect the first rectifier device and the inverter device to the battery in a traction configuration, to allow the battery to power the said double-winding electric motor.

4. The electric vehicle according to claim 3, wherein in the traction configuration, the second rectifier device remains electrically connected to the battery and the said double-winding electric motor.

5. The electric vehicle according to claim 4, wherein the second rectifier device, in the traction configuration, defines a galvanic separation between the battery and the second winding of the double-winding electric motor.

6. The electric vehicle according to claim 3, wherein the first and the second deviating means are configured to separate the first rectifier device and the inverter device from the battery in a charging configuration, to allow the power supply station to charge the battery.

7. The electric vehicle according to claim 3, comprising third deviating means electrically interposed between the first rectifier device and the second winding of the said double-winding electric motor.

8. The electric vehicle according to claim 7, wherein the third deviating means are configured to connect the power supply station to the first rectifier device in the charging configuration and to connect the first rectifier device to the second winding of the said double-winding electric motor in the traction configuration.

9. The electric vehicle according to claim 1, wherein the second rectifier device is a passive device not controlled from the outside.

10. The electric vehicle according to claim 1, wherein the inverter device is configured to generate the first three-phase alternating electrical voltage with a frequency between 500 Hz and 5 kHz.

11. The electric-vehicle according to claim 1, wherein the double-winding electric motor is a motor comprising a stator equipped with a first three-phase winding electrically connected to the inverter device of the conversion station and a second three-phase winding electrically connected to the battery, magnetically coupled to the first three-phase winding and allowed to be crossed by a second three-phase alternating voltage induced by the first three-phase alternating electrical voltage; the first three-phase winding and the second three-phase winding are magnetically coupled and are configured to act as a three-phase transformer thus defining the galvanic separation.

12. The electric vehicle according to claim 1, wherein the said conversion station comprises the second rectifier device electrically interposed between the galvanic separation device and the battery and configured to convert the second three-phase alternating voltage in the second substantially continuous voltage to charge the battery.

13. The electric vehicle according to claim 1, wherein the first substantially continuous electrical voltage delivered by the first rectifier device is always greater than the second substantially continuous voltage delivered by the second rectifier device.

14. The electric vehicle according to claim 1, comprising at least one electronic control unit operatively associated with the power supply station and the conversion station and configured to detect electrical control quantities, comprising a electric power supply voltage and/or an electric power supply current of the electric power supply and/or an electric recharging voltage and/or an electric recharging current of the electric recharging power and to control the inverter device to supplying the first three-phase alternating electrical voltage controlled based on the electrical control quantities.

15. The electric vehicle according to claim 14, wherein the electronic control unit comprises at least one processing module configured to process the electrical control quantities and calculate at least one magnetic flux value of the double-winding electric motor; the first three-phase alternating electrical voltage is controlled based on the magnetic flux value.

16. The electric vehicle according to claim 5, wherein the electronic control unit comprises the at least one processing module configured to process the electrical control quantities and calculate the at least one value of the sum of electric currents flowing in the first winding and the second winding of the double-winding electric motor;
the first three-phase alternating electrical voltage is controlled based on the value of the sum of the electric currents flowing in the first winding and the second winding of the double-winding electric motor.

17. The electric vehicle according to claim 1, wherein the power supply station is configured to be electrically connected to a single-phase or three-phase power supply source.

18. A method for mounting a recharging apparatus of at least one battery in an electric vehicle, wherein the method comprises:
at least one preparation step of the recharging apparatus of the at least one battery, wherein the recharging apparatus comprises:
a power supply station configured to be electrically connected to a source of electrical power supply;
a conversion station, electrically connected to the power supply station and configured to convert the electric feeding power into an electric recharging power allowed to charge the battery;
the conversion station comprises at least one galvanic separation device intended to be electrically interposed between the power supply station and the battery and configured to electrically separate the battery from the source of electric power supply,
wherein the galvanic separation device comprises a double winding double-winding electric motor adapted to allow a movement of the electric vehicle,
wherein first winding is electrically connected with the power supply station and
wherein second winding is electrically connected with the battery and magnetically coupled and electrically separated with respect to the first winding;
at least one installation phase of the recharging apparatus inside the electric vehicle.

19. The electric vehicle according to claim 1, wherein the inverter device is configured to generate the first three-phase alternating electrical voltage with a frequency between 500 Hz and 800 Hz.
